(19) United States
(12) Patent Application Publication
(10) Pub. No.: US 2005/0086504 A1
(43) Pub. Date: Apr. 21, 2005

(54) Method of authenticating device using certificate, and digital content processing device for performing device authentication using the same

(75) Inventors: Yong-kuk You, Suwon-si (KR); Myung-sun Kim, Uiwang-si (KR); Yong-jin Jang, Uiwang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/927,239

(22) Filed: Aug. 27, 2004

(30) Foreign Application Priority Data
Oct. 17, 2003 (KR) 10-2003-0072698

(51) Int. Cl. G06F 12/14; H04L 9/32

(52) U.S. Cl. 713/193; 713/156

(57) ABSTRACT

Methods of authenticating a device using a certificate, and digital content processing devices for performing device authentication using the methods are disclosed. The method of authenticating a digital content processing device includes generating first secret information on a first digital content processing device with a public key for encryption/decryption of digital content, generating a first certificate using the generated first secret information and the public key and a device identifier of the first digital content processing device, transmitting the generated first certificate to a second digital content processing device, generating second secret information on the second digital content processing device, generating a second certificate using the generated second secret information and the public key and the device identifier of the first digital content processing device, and comparing the generated first certificate with the generated second certificate to confirm whether both the certificates are the same.

### BACKGROUND OF THE INVENTION

This application claims the priority of Korean Patent Application No. 10-2003-0072698 filed on Oct. 17, 2003, in the Korean Intellectual Property Office, the disclosure of which is incorporated herein in its entirety by reference.

1. Field of the Invention

The present invention relates to authentication of a device capable of transmitting and receiving digital content, and more particularly, to a method of authenticating a device using a certificate, and a digital content processing device for performing device authentication using the above method.

2. Description of the Related Art

Encryption is a technique for protecting data, and an encryption algorithm produces encrypted data, i.e. ciphertext, by mathematically combining an encryption key with input general text data. If a good encryption algorithm is used, it is computationally impossible, in any practical sense, to obtain the general text data by reversing the encryption procedure with only the ciphertext. To obtain the general text data, additional data and a decryption key are further required.

In conventional private (or symmetrical) key encryption, a private key for use in encrypting and decrypting a message is produced and shared. Since the encryption key and the decryption key are identical to each other, important data need be shared. Accordingly, parties who want to transfer information using private key encryption should exchange encryption and decryption keys with one another in order to exchange encrypted data. However, a system according to this scheme has a fatal drawback in that a message can be easily decrypted if the private key is known or intercepted by other persons. Accordingly, a public key encryption scheme based on a public key infrastructure has been proposed.

The public key infrastructure comprises digital certificates including public keys and information on the public keys, a certificate authority for issuing and verifying the digital certificates, a registration authority for performing authentication on the behalf of the certificate authority before the digital certificates are issued to applicants, and one or more directories for storing certificates having public keys.

Each digital certificate issued by the certificate authority includes the owner's name, a serial number, period of validity, a copy of the public key of the certificate owner, an electronic signature of the certificate authority and the like, so that a recipient can confirm the authenticity of the certificate. The form of the digital certificate most commonly used at present is based on ITU-T X.509 standards.

A certificate based on X.509 standards includes fields such as version, serial number, signature algorithm, ID issuer's name, period of validity, owner's name, owner's public key information, issuer's unique ID (only in Versions 2 and 3), owner's unique ID (only in Version 2 and 3), extension (only in Version 3), signatures thereof, etc. The certificate is bound by the owner's name and the user's public key and is signed by an issuer. The X.509 standards define the syntax for certificate revocation lists (CRLs), i.e., lists of certificates that have been revoked before their scheduled expiration data, and are supported by many protocols including PEM, PKCS, S-HTTP, and SSL.

In addition thereto, there are certificates in various formats. For example, a Pretty Good Privacy (PGP) security electronic mail uses a certificate format for only PGP. PGP products allow a message to be encrypted and sent to anyone who has a public key via electronic mail. When a message is encrypted by using a recipient's public key and is then sent, the recipient decrypts the message by using his/her own private key. PGP users share a public key directory called “keyring.” At this time, when a message is sent to a person who cannot access the keyring, an encrypted message cannot be sent to him/her. Alternatively, the PGP allows a sender who sends a message to sign the message with a digital certificate by using his/her own private key. Then, a recipient receives the sender's public key and decrypts the encrypted signature in order to confirm the authenticity of the sender.

The digital certificate can be stored in a registry so that authenticated users can view the public keys of other users.

The certificate authority is an authority on a network, which determines whether a message has proper qualifications for security, and issues and manages public keys for encryption and decryption of messages. The certificate authority, which is a part of the public key infrastructure, checks the safety or the like of a message together with the registration authority for verifying information provided by a person requesting a digital certificate.

The registration authority is an authority on a network, which verifies a user's request for a digital certificate and causes the certificate authority to issue the digital certificate. Accordingly, when the registration authority proves that information on the user is eligible, the certificate authority can issue a digital certificate.

In the public key encryption scheme, a certificate authority simultaneously creates a public key and a private key by using the same algorithm. The private key is given only to an individual and the public key is opened as a part of a digital certificate in a directory accessible by anyone. The private key is never shared with other persons or transmitted through the Internet. A user utilizes his/her own private key in order to decrypt text which has been encrypted by someone using the user's public key found from the opened directory. Accordingly, if the user sends a message to someone, he/she finds a public key of the intended recipient through the certificate authority, encrypts the message using the public key and sends the encrypted message. The recipient that has received the encrypted message decrypts the message using his/her own private key. In addition to the encryption of the message, the sender can show his/her own authenticity by sending a digital certificate encrypted by using his/her own private key.

Namely, the recipient's public key is used to encrypt a message for sending and the recipient's private key is used to decrypt the encrypted message. Further, the sender's private key is used to encrypt a signature for sending and the sender's public key is used to decrypt the encrypted signature and to thus authenticate the sender.

Many new techniques have been developed in such a manner that the public key and private key are kept separated using the public key encryption scheme. Important parts of these techniques include a digital signature, a distributed authentication, a private key agreement through a public key, encryption of a large volume of data without a private key pre-sharing, and the like.

In addition, there have been developed public key encryption algorithms for performing the public key encryption scheme. For example, algorithms such as RSA (Rivest-Shamir-Adleman) or ECC (Elliptic Curve Cryptography) belong to general-purpose algorithms in that they can support all operations related to public key encryption. Alternatively, there are algorithms capable of supporting only a part of such an operation. For example, a digital signature algorithm (DSA) is used only for a digital signature and a Diffie-Hellman (D-H) algorithm is used only for a private key agreement.

FIG. 1 is an exemplary view showing a public key certificate list managed by an external certificate authority. The external certificate authority lists, opens, maintains and manages public key certificates, each of which is a combination of an ID and public key of a user that is signed by a private key S_{SK}_{_{—}}_{CA} of the certificate authority. Then, if it is necessary to confirm the other party's certificate, each user extracts a public key certificate to be confirmed by downloading the public key certificate list issued by the certificate authority through a network or directly connecting with the certificate authority to access the public key certificate list. At this time, the authenticity of the user's ID and public key can be confirmed by decrypting the certificate using the public key S_{SK}_{_{—}}_{CA} of the certificate authority.

However, when the aforementioned public key certificate scheme is employed for device authentication among devices belonging to a home network, there is inconvenience in that a separate server for device authentication must be established, maintained and managed inside or outside the home network. Accordingly, there is a need for confirming the authenticity of devices by using the public key certificate within the home network, without requiring such a separate server for device authentication.

### SUMMARY OF THE INVENTION

The present invention is conceived to solve the aforementioned problem. An object of the present invention is to provide a method of performing device authentication among digital content processing devices by confirming the validity of public keys when the devices constituting a home network use their own public keys.

According to an exemplary aspect of the present invention for achieving the object, there is provided a digital content processing device for performing device authentication using a certificate, the digital content processing device comprising a secret information generating unit for generating secret information on the digital content processing device; a certificate generating unit for generating a certificate using the generated secret information and a public key of the digital content processing device for encryption/decryption of digital content; and a transmitting unit for transmitting the generated certificate to another digital content processing device.

The secret information generating unit may generate the secret information by using a set of private keys for generating the secret information, and device identification information received through a digital content transmission medium. At this time, the device identification information preferably, but not necessarily, includes revocation information on the digital content processing device.

Further, the certificate generated in the certificate generating unit preferably, but not necessarily, includes a result value of a cryptographically strong one-way function with the generated secret information and the public key as input values, which may be a result value of a hash function, a result value of a message authentication code (MAC) function with the generated secret information as a key value and with the public key as an input, or a result value derived from encryption of the public key with the generated secret information as a key value.

According to another exemplary aspect of the present invention, there is provided a digital content processing device for performing device authentication using a certificate, the digital content processing device comprising a receiving unit for receiving a first certificate from another digital content processing device; a secret information generating unit for generating secret information on the digital content processing device; a certificate generating unit for generating a second certificate using the generated secret information and a public key of the digital content processing device; and a certificate verifying unit for comparing the received first certificate with the generated second certificate.

According to a further exemplary aspect of the present invention, there is provided a digital content processing device for performing device authentication using a certificate, the digital content processing device comprising a secret information generating unit for generating secret information on the digital content processing device; a certificate generating unit for generating a certificate using the generated secret information, a public key of the digital content processing device for encryption/decryption of digital content, and a device identifier of the digital content processing device; and a transmitting unit for transmitting the generated certificate to another digital content processing device.

The secret information generating unit may generate the secret information by using a set of private keys for generating the secret information, and device identification information received through a digital content transmission medium. At this time, the device identification information preferably, but not necessarily, includes revocation information on the digital content processing device.

Further, the certificate generated in the certificate generating unit preferably, but not necessarily, includes a result value of a cryptographically strong one-way function with the generated secret information, the public key and the device identifier as input values, which may be a result value of a hash function, a result value of a message authentication code (MAC) function with the generated secret information as a key value and with the public key as an input, or a result value derived from encryption of the public key and the device identifier with the generated secret information as a key value.

According to a still further exemplary aspect of the present invention, there is provided a digital content processing device for performing device authentication using a certificate, the digital content processing device comprising a receiving unit for receiving a first certificate from another digital content processing device; a secret information generating unit for generating secret information on the digital content processing device; a certificate generating unit for generating a second certificate using the generated secret information and a public key and device identifier of the digital content processing device; and a certificate verifying unit for comparing the received first certificate with the generated second certificate.

According to a still further exemplary aspect of the present invention, there is provided a method of authenticating a digital content processing device using a certificate, the method comprising a first step of generating first secret information on a first digital content processing device with a public key for encryption/decryption of digital content; a second step of generating a first certificate using the generated first secret information and the public key; a third step of transmitting the generated first certificate to a second digital content processing device; a fourth step of generating second secret information on the second digital content processing device; a fifth step of generating a second certificate using the generated second secret information and the public key; and a sixth step of comparing the first certificate generated in the second step with the second certificate generated in the fifth step to confirm whether both certificates are the same.

The first step may be the step of generating the first secret information using a set of private keys of the first digital content processing device for generating the first secret information, and first device identification information received by the first digital content processing device through a digital content transmission medium, and the fourth step may be the step of generating the second secret information using a set of private keys of the second digital content processing device for generating the second secret information, and second device identification information received by the second digital content processing device through the digital content transmission medium. At this time, the device identification information preferably, but not necessarily, includes revocation information on the digital content processing device.

The first certificate generated in the second step may include a result value of a hash function with the generated first secret information and the public key as input values, and the second certificate generated in the fifth step may include a result value of a hash function with the generated second secret information and the public key as input values.

The first certificate generated in the second step may include a result value of a message authentication code (MAC) function with the generated first secret information as a key value and with the public key as an input value, and the second certificate generated in the fifth step may include a result value of a MAC function with the generated second secret information as a key value and with the public key as an input value.

The first certificate generated in the second step may include a result value derived from encryption of the public key with the generated first secret information as a key value, and the second certificate generated in the fifth step may include a result value derived from encryption of the public key with the generated second secret information as a key value.

According to a still further exemplary aspect of the present invention, there is provided a method of authenticating a digital content processing device using a certificate, the method comprising a first step of generating first secret information on a first digital content processing device with a public key for encryption/decryption of digital content; a second step of generating a first certificate using the generated first secret information and the public key and a device identifier of the first digital content processing device; a third step of transmitting the generated first certificate to a second digital content processing device; a fourth step of generating second secret information on the second digital content processing device; a fifth step of generating a second certificate using the generated second secret information and the public key and the device identifier of the first digital content processing device; and a sixth step of comparing the first certificate generated in the second step with the second certificate generated in the fifth step to confirm whether both certificates are the same.

The first step may be the step of generating the first secret information using a set of private keys of the first digital content processing device for generating the first secret information, and first device identification information received by the first digital content processing device through a digital content transmission medium, and the fourth step may be the step of generating the second secret information using a set of private keys of the second digital content processing device for generating the second secret information, and second device identification information received by the second digital content processing device through the digital content transmission medium. At this time, the device identification information preferably, but not necessarily, includes revocation information on the digital content processing device.

The first certificate generated in the second step may include a result value of a hash function with the generated first secret information, the device identifier and the public key as input values, and the second certificate generated in the fifth step may include a result value of a hash function with the generated second secret information, the device identifier and the public key as input values.

The first certificate generated in the second step may include a result value of a message authentication code (MAC) function with the generated first secret information as a key value and with the device identifier and the public key as input values, and the second certificate generated in the fifth step may include a result value of a MAC function with the generated second secret information as a key value and with the device identifier and the public key as input values.

The first certificate generated in the second step may include a result value derived from encryption of the device identifier and the public key with the generated first secret information as a key value, and the second certificate generated in the fifth step may include a result value derived from encryption of the device identifier and the public key with the generated second secret information as a key value.

### BRIEF DESCRIPTION OF THE DRAWINGS

The above and other objects, features and advantages of the present invention will become apparent from the following description of illustrative, non-limiting embodiments given in conjunction with the accompanying drawings, in which:

FIG. 1 is an exemplary view showing a public key certificate list managed by an external certificate authority;

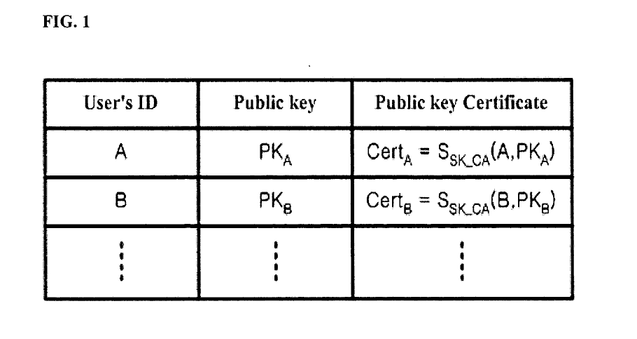

FIG. 2 is a block diagram showing a digital content processing device for performing device authentication using a certificate according to an illustrative embodiment of the present invention; and

FIG. 3 is a view showing a digital content processing procedure for performing device authentication using a certificate according to another illustrative embodiment of the present invention.

### DETAILED DESCRIPTION OF THE INVENTION

Hereinafter, a method of authenticating a device using a certificate, and a digital content processing device for performing device authentication using the above method according to illustrative embodiments of the present invention will be described in detail with reference to the accompanying drawings.

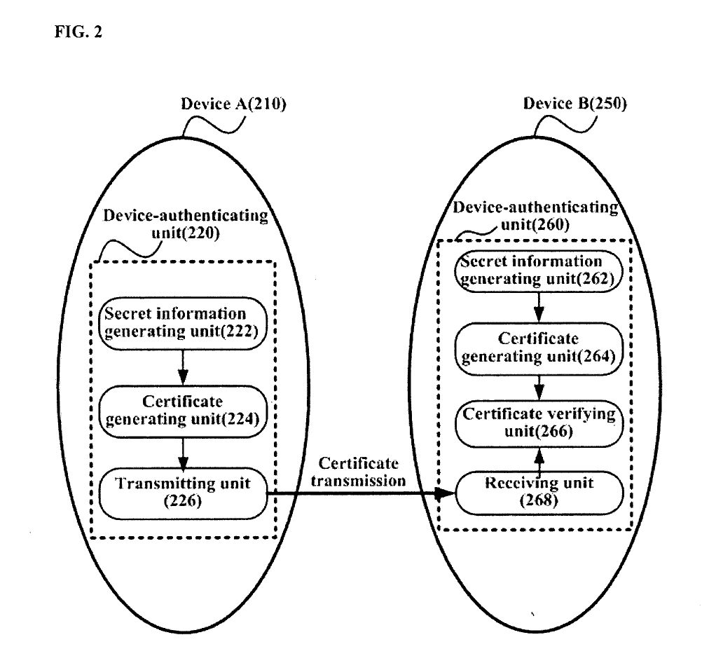

FIG. 2 is a block diagram showing a digital content processing device for performing device authentication using a certificate according to an illustrative embodiment of the present invention.

In FIG. 2, device A 210 and device B 250 are devices for reproducing or recording digital content and respectively include device-authenticating units 220 and 260 for confirming the authenticity of devices between the devices.

The device-authenticating units 220 and 260 can be implemented with hardware or software. Since each device can transmit/receive digital content, the device-authenticating units 220 and 260 are configured with the same block structure.

However, in order to facilitate the description of the present invention, FIG. 2 shows the device-authenticating unit 220 of device A 210 for transmitting a certificate and the device-authenticating unit 260 of device B 250 for receiving the certificate as only physical or logical blocks for performing their functions.

Specifically, the device-authenticating unit 220 of device A 210 for transmitting a certificate includes a secret information generating unit 222 that generates secret information for reproducing or recording digital content, a certificate generating unit 224 for generating a certificate using the secret information, and a transmitting unit 226 for transmitting the generated certificate. In addition, the device-authenticating unit 260 of device B 250 for receiving the certificate transmitted from device A 210 includes a receiving unit 268 for receiving the certificate, a secret information generating unit 262 that generates secret information for reproducing or recording the digital content, a certificate generating unit 264 for generating a certificate using the secret information, and a certificate verifying unit 266 for comparing the certificate received from device A 210 with the certificate generated in the certificate generating unit 264.

In order to reproduce or record digital content, which is owned by device A 210, in device B 250, it is first determined whether device B 250 is a legitimate device capable of processing the digital content, i.e., a device authentication procedure is performed. If it is verified through the device authentication procedure that device B 250 is a legitimate device, device A 210 transmits the digital content to device B 250. Hereinafter, the device authentication procedure using a certificate will be specifically described by way of example in connection with devices belonging to a home network.

In devices for processing digital content according to an illustrative embodiment of the present invention, a set of private keys, DK1, DK2, DK3, DK4, . . . , DKn for the confirmation of device revocation is assigned thereto and stored upon manufacture of the devices. The set of private keys cannot be changed and also cannot be checked from the outside. In addition, the devices have a function by which they can be beforehand assigned a pair of keys including a public key and a private key and generate the pair of keys, and have respective device IDs for identifying the devices. At this time, the public key can be opened so that it is known to the devices belonging to the home network or is easily accessible by other devices by being stored in a database belonging to the home network.

On the other hand, a content provider (not shown) providing digital content generates a revocation information block so that only legitimate devices can restore secret values corresponding to secret information on the devices, based on information on devices to be revoked. If a device is hacked by an unauthorized third person and all secret information including the public key of the device is revealed, the device is revoked and the public key of the device is disabled. Accordingly, in this case, the device cannot restore the secret value from the revocation information block any longer. At this time, the revocation information block can be made using a broadcast encryption scheme.

The revocation information block is transmitted to the devices constituting the home network via a digital content storage medium or a wired/wireless network. In a case where the revocation information block is transmitted via the digital content storage medium such as a disk, the term “media key block” is used and it can be determined through such information whether a device will be revoked.

The secret information generating unit 222 of the device-authenticating unit 220 of device A 210 extracts a secret value (hereinafter, referred to as “K”) corresponding to secret information for processing the digital content from the revocation information block by using the set of private keys. If device A 210 is a revoked device, K cannot be extracted. For the sake of convenience, it is assumed that the secret value K is a reasonable value.

The certificate generating unit 224 generates a certificate by using K, a device ID of device A 210 (hereinafter, referred to as “DeviceIDa”), and a public key of device A 210 (hereinafter, referred to as “PublicKeyA”).

Examples of methods of generating the certificate are represented by the following formulas 1, 2 and 3. In these formulas, H(A∥B) represents a result value of a hash function with input factors of consecutively arranged A and B, MAC(A)K is a result value of a message authentication code (MAC) function with a key value of K and an input value of A, and E(A)K is a result value obtained from the encryption of A with the key value of K. These functions are cryptographically strong, one-way functions for which results cannot be estimated if K is not known. The secret value K can be obtained only when a set of legitimate private keys is known. If an unauthorized third person attempts to generate a certificate having another ID and public key, he/she cannot generate the certificate if he/she cannot estimate the secret value K.
Cert_{A}=H(DeviceIDa∥PublicKeyA∥K) (1)
Cert_{A}=MAC(DeviceIDa∥PublicKeyA)K (2)
Cert_{A}=E(DeviceIDa∥PublicKeyA)K (3)

In formula 1, certificate Cert_{A} can be the result value of the hash function H with a DeviceIDa value corresponding to the device ID of device A, a PublicKeyA value corresponding to the public key of device A, and the secret value K known by device A, which are randomly arranged, as input values of the hash function H.

In formula 2, certificate Cert_{A} can be the result value of the MAC function with the DeviceIDa value corresponding to the device ID of device A and the PublicKeyA value corresponding to the public key of device A, which are randomly arranged, as input values and with the secret value K known by device A as a key value.

In formula 3, certificate Cert_{A} can be the result value derived when the DeviceIDa value corresponding to the device ID of device A and the PublicKeyA value corresponding to the public key of device A, which are randomly arranged, are encrypted using the secret value K known by device A.

Using the methods represented by formulas 1 to 3, only devices knowing the secret value K can prepare a correct certificate Cert_{A} and, thus, device A can prove that it knows the secret value K without directly showing the secret value K. In addition, the fact that device A knew the secret value K proves that device A is a legitimate device that has not been revoked. This is because if the public key of a device cannot be used any longer, the device will be revoked. Therefore, a correct certificate Cert_{A} proves the authenticity of the public key.

Meanwhile, the DeviceIDa can be made by a one-way function such as the hash function H(PublicKeyA) with the public key as an input value. Accordingly, since only authentication for the public key is required in such a case, a certificate can be produced from formulas 1 to 3 excluding the DeviceIDa from the input values thereof. This is represented by the following formulas 4 to 6.
Cert_{A}=H(PublicKeyA∥K) (4)
Cert_{A}=MAC(PublicKeyA)K (5)
Cert_{A}=E(PublicKeyA)K (6)

In formula 4, certificate Cert_{A} can be the result value of the hash function H with the PublicKeyA value corresponding to the public key of device A and the secret value K known by device A, which are randomly arranged, as input values of the hash function H.

In formula 5, certificate Cert_{A} can be the result value of the MAC function with the PublicKeyA value corresponding to the public key of device A as an input value and with the secret value K known by device A as a key value.

In formula 6, certificate Cert_{A} can be the result value derived when the PublicKeyA value corresponding to the public key of device A is encrypted using the secret value K known by device A.

When the certificate generating unit 224 generates a certificate according to any one of the methods represented by formulas 1 to 6, the transmitting unit 226 transmits the generated certificate to the receiving unit 268 of the device-authenticating unit 260 of device B 250 via a wired/wireless network enabling communications between the devices.

Meanwhile, the secret information generating unit 262 of the device-authenticating unit 260 of device B generates a secret value K′ in the same manner as the generation of the secret value K in the secret information generating unit 222. Then, a certificate can be generated by any one of the methods represented by formulas 1 to 6. This is represented by the following formulas 7 to 12. At this time, all Ids (DeviceIDs) and public keys (PublicKeys) of devices belonging to a home network are known to the devices belonging to the home network.
Cert_{A}′=H(DeviceIDa∥PublicKeyA∥K′) (7)
Cert_{A}′=MAC(DeviceIDa∥PublicKeyA)K′ (8)
Cert_{A}′=E(DeviceIDa∥PublicKeyA)K′ (9)
Cert_{A}′=H(PublicKeyA∥K′) (10)
Cert_{A}′=MAC(PublicKeyA)K′ (11)
Cert_{A}′=E(PublicKeyA)K′ (12)

In formula 7, certificate Cert_{A}′ can be the result value of the hash function H with the DeviceIDa value corresponding to the device ID of device A, the PublicKeyA value corresponding to the public key of device A, and the secret value K′ known by device B, which are randomly arranged, as input values of the hash function H.

In formula 8, certificate Cert_{A}′ can be the result value of the MAC function with the DeviceIDa value corresponding to the device ID of device A and the PublicKeyA value corresponding to the public key of device A, which are randomly arranged, as input values and with the secret value K′ known by device B as a key value.

In formula 9, certificate Cert_{A}′ can be the result value derived when the DeviceIDa value corresponding to the device ID of device A and the PublicKeyA value corresponding to the public key of device A, which are randomly arranged, are encrypted using the secret value K′ known by device B.

In formula 10, certificate Cert_{A}′ can be the result value of the hash function H with the PublicKeyA value corresponding to the public key of device A and the secret value K′ known by device B, which are randomly arranged, as input values of the hash function H.

In formula 11, certificate Cert_{A}′ can be the result value of the MAC function with the PublicKeyA value corresponding to the public key of device A as an input value and with the secret value K′ known by device B as a key value.

In formula 12, certificate Cert_{A}′ can be the result value derived when the PublicKeyA value corresponding to the public key of device A is encrypted using the secret value K′ known by device B.

The certificate verifying unit 266 of the device-authenticating unit 260 of device B 250 compares certificate Cert_{A} with certificate Cert_{A}′. If both the certificates are equal to each other, it can b econsidered that K=K′. Accordingly, it is confirmed that device B 250 is a legitimate device capable of processing digital content. If device B 250 is to be revoked, K′ satisfying the condition of K=K′ cannot be obtained. Thus, device B 250 cannot reproduce or record digital content received from device A 210.

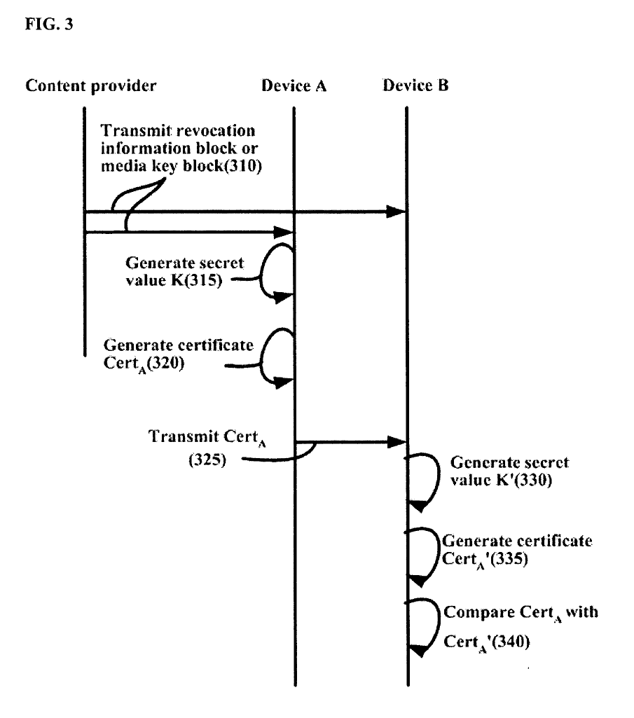

FIG. 3 is a view showing a digital content processing procedure for performing device authentication using a certificate according to another illustrative embodiment of the present invention.

In FIG. 3, it is assumed that device A and device B belong to the same home network and can reproduce or record digital content and a content provider resides outside the home network. At this time, the content provider may be a content producer that produces content by itself, or a content distributor that provides content or a storage media with the content recorded therein without producing the content.

The content provider transmits a revocation information block as information on devices incapable of processing content to device A and device B via digital content storage media or a wired/wireless network (310).

A set of private keys DK1, DK2, DK3, DK4, . . . , DKn is assigned to and stored in device A upon manufacture of device A in order to confirm device revocation. With this set of private keys, a secret value K corresponding to secret information for processing the digital content is generated from a revocation information block that is information received from the content provider (315). At this time, for the sake of convenience of explanation, it is assumed that the secret value K is a legitimate value.

Then, certificate Cert_{A} is generated using the secret value K and the device ID and public key of device A (320) and is then transmitted to device B (325). At this time, exemplary methods of generating certificate Cert_{A} are represented by formulas 1 to 6.

Device B generates a secret value K′ in the same manner as in step 315 (330) and generates certificate Cert_{A}′ using the secret value K′ and the device ID and public key of device A (335). At this time, the device ID and public key of device A are known to all devices present in the home network to which device A and device B belong. Meanwhile, exemplary methods of generating certificate Cert_{A}′ are represented by the formulas 7 to 12.

Device B compares certificate Cert_{A} with certificate Cert_{A}′. If both the certificates are equal to each other, it is confirmed that device B is a legitimate device capable of processing the digital content (340).

With a device authentication method and digital content processing device for performing device authentication using the method according to the present invention described above, the device authentication using a certificate among devices belonging to a home network can be simply and conveniently performed without using an external certificate authority.

Although the present invention has been described in connection with the illustrative embodiments and the accompanying drawings, it is not limited thereto since those skilled in the art can make various modifications and changes without departing from the scope and spirit of the invention.

1. A digital content processing device, comprising:
a secret information generating unit for generating secret information on the digital content processing device;
a certificate generating unit for generating a certificate using the generated secret information and a public key of the digital content processing device for encryption/decryption of digital content; and
a transmitting unit for transmitting the generated certificate to another digital content processing device.

2. The device as claimed in claim 1, wherein the secret information generating unit generates the secret information by using a set of private keys for generating the secret information, and device identification information received through a digital content transmission medium.

3. The device as claimed in claim 2, wherein the device identification information includes revocation information on the digital content processing device.

4. The device as claimed in claim 2, wherein the device identification information includes media key block information.

5. The device as claimed in claim 1, wherein the certificate generated in the certificate generating unit includes a result value of a hash function with the generated secret information and the public key as input values.

6. The device as claimed in claim 1, wherein the certificate generated in the certificate generating unit includes a result value of a message authentication code (MAC) function with the generated secret information as a key value and with the public key as an input value.

7. The device as claimed in claim 1, wherein the certificate in the certificate generating unit includes a result value derived from encryption of the public key with the generated secret information as a key value.

8. A digital content processing device, comprising:
a receiving unit for receiving a first certificate from an other digital content processing device;
a secret information generating unit for generating secret information on the digital content processing device;
a certificate generating unit for generating a second certificate using the generated secret information and a public key of the other digital content processing device; and
a certificate verifying unit for comparing the received first certificate with the generated second certificate.

9. A digital content processing device, comprising:
a secret information generating unit for generating secret information on the digital content processing device;
a certificate generating unit for generating a certificate using the generated secret information, a public key of the digital content processing device for encryption/decryption of digital content, and a device identifier of the digital content processing device; and
a transmitting unit for transmitting the generated certificate to another digital content processing device.

10. The device as claimed in claim 9, wherein the secret information generating unit generates the secret information by using a set of private keys for generating the secret information, and device identification information received through a digital content transmission medium.

11. The device as claimed in claim 10, wherein the device identification information includes revocation information on the digital content processing device.

12. The device as claimed in claim 10, wherein the device identification information includes media key block information.

13. The device as claimed in claim 9, wherein the certificate generated in the certificate generating unit includes a result value of a hash function with the generated secret information and the public key as input values.

14. The device as claimed in claim 9, wherein the certificate generated in the certificate generating unit includes a result value of a message authentication code (MAC) function with the generated secret information as a key value and with the public key as an input value.

15. The device as claimed in claim 9, wherein the certificate in the certificate generating unit includes a result value derived from encryption of the public key with the generated secret information as a key value.

16. A digital content processing device, comprising:
a receiving unit for receiving a first certificate from an other digital content processing device;
a secret information generating unit for generating secret information on the digital content processing device;
a certificate generating unit for generating a second certificate using the generated secret information, and a public key and device identifier of the other digital content processing device; and
a certificate verifying unit for comparing the received first certificate with the generated second certificate.

17. A method of authenticating a digital content processing device, comprising:
generating first secret information on a first digital content processing device having a public key for encryption/decryption of digital content;
generating a first certificate using the generated first secret information and the public key;
transmitting the generated first certificate to a second digital content processing device;
generating second secret information on the second digital content processing device;
generating a second certificate using the generated second secret information and the public key; and
comparing the first certificate with the second certificate to confirm whether both the certificates are the same.

18. The method as claimed in claim 17, wherein the step of generating first secret information comprises generating the first secret information using a set of private keys of the first digital content processing device, and first device identification information received by the first digital content processing device through a digital content transmission medium.

19. The method as claimed in claim 18, wherein the first device identification information includes revocation information on the first digital content processing device.

20. The method as claimed in claim 18, wherein the first device identification information includes media key block information.

21. The method as claimed in claim 17, wherein the step of generating second secret information comprises generating the second secret information using a set of private keys of the second digital content processing device, and second device identification information received by the second digital content processing device through a digital content transmission medium.

22. The method as claimed in claim 21, wherein the second device identification information includes revocation information on the second digital content processing device.

23. The method as claimed in claim 21, wherein the second device identification information includes media key block information.

24. The method as claimed in claim 17, wherein the first certificate includes a result value of a hash function with the generated first secret information and the public key as input values, and the second certificate includes a result value of the hash function with the generated second secret information and the public key as input values.

25. The method as claimed in claim 17, wherein the first certificate includes a result value of a message authentication code (MAC) function with the generated first secret information as a key value and with the public key as an input value, and the second certificate includes a result value of the MAC function with the generated second secret information as a key value and with the public key as an input value.

26. The method as claimed in claim 17, wherein the first certificate includes a result value derived from encryption of the public key with the generated first secret information as a key value, and the second certificate includes a result value derived from encryption of the public key with the generated second secret information as a key value.

27. A method of authenticating a digital content processing device, comprising:
generating first secret information on a first digital content processing device with a public key for encryption/decryption of digital content;
generating a first certificate using the generated first secret information, and the public key and a device identifier of the first digital content processing device;
transmitting the generated first certificate to a second digital content processing device;
generating second secret information on the second digital content processing device;
generating a second certificate using the generated second secret information, and the public key and the device identifier of the first digital content processing device; and
comparing the first certificate with the second certificate to confirm whether both the certificates are the same.

28. The method as claimed in claim 27, wherein the step of generating first secret information comprises generating the first secret information using a set of private keys of the first digital content processing device, and first device identification information received by the first digital content processing device through a digital content transmission medium.

29. The method as claimed in claim 28, wherein the first device identification information includes revocation information on the first digital content processing device.

30. The method as claimed in claim 28, wherein the first device identification information includes media key block information.

31. The method as claimed in claim 27, wherein the step of generating second secret information comprises generating the second secret information using a set of private keys of the second digital content processing device, and second device identification information received by the second digital content processing device through the digital content transmission medium.

32. The method as claimed in claim 31, wherein the second device identification information includes revocation information on the second digital content processing device.

33. The method as claimed in claim 31, wherein the second device identification information includes media key block information.

34. The method as claimed in claim 27, wherein the first certificate includes a result value of a hash function with the generated first secret information, the device identifier and the public key as input values, and the second certificate includes a result value of the hash function with the generated second secret information, the device identifier and the public key as input values.

35. The method as claimed in claim 27, wherein the first certificate includes a result value of a message authentication code (MAC) function with the generated first secret information as a key value, and with the device identifier and the public key as input values, and the second certificate includes a result value of the MAC function with the generated second secret information as a key value, and with the device identifier and the public key as input values.

36. The method as claimed in claim 27, wherein the first certificate includes a result value derived from encryption of the device identifier and the public key with the generated first secret information as a key value, and the second certificate includes a result value derived from encryption of the device identifier and the public key with the generated second secret information as a key value.
